(19) United States
(12) Patent Application Publication
(10) Pub. No.: US 2022/0356008 A1
(43) Pub. Date: Nov. 10, 2022

(54) BULK BIN LID OPENER

(71) Applicant: Barntools, LLC, West Des Moines, IA (US)

(72) Inventor: Lloyd D Snell, Ames, IA (US)

(21) Appl. No.: 17/719,044

(22) Filed: Apr. 12, 2022

Related U.S. Application Data
(60) Provisional application No. 63/183,750, filed on May 4, 2021.

(51) Int. Cl. B65D 90/66; B65D 90/10; B65D 90/62

(52) U.S. Cl. CPC B65D 90/66; B65D 90/10; B65D 90/623; B65D 2590/664; B65D 2590/668

(57) ABSTRACT

A system for opening a lid of a bin comprises a guide channel plate comprising an elongated member, a first guide channel comprising a first slot formed within and along the length of the guide channel plate, and a second guide channel comprising a second slot formed within and along the length of the guide channel plate and parallel to the first guide channel slot. A block plate fits within the first and second guide channels and is secured by a block plate clamp. The block plate connects to a linear actuator that is secured to a support member of the bin. A slide block fits compressively within the first and second guide channels thus securing a flexible link assembly and wherein the slide block connects to the linear actuator. A connector plate allows connecting and disconnecting of the linear actuator.

### CROSS-REFERENCE TO RELATED APPLICATIONS

This patent application claims priority to U.S. Provisional Patent Application No. 63/183,750 filed on May 4, 2021, the entirety of which is incorporated herein fully by reference.

### FIELD OF THE DISCLOSURE

This disclosure relates to an improved bulk bin lid opener system for controlling access, remotely opening and closing, and easily disconnecting the actuator if manual operation is required.

### BACKGROUND OF THE DISCLOSURE

To continuously improve bio-security in the food supply chain, control and monitoring is being extended to all input activities related to production. Today, personnel movement between facilities is monitored to prevent entry into a non-infected facility after exposure to infected facility. One input in the production of protein is the feed supplies which are delivered by a common truck and driver to bulk feed bins located on the property outside of the production building. A truck and driver travel to and between disease infected facilities and non-infected facilities on the same route potentially spreading disease.

The disease transfer could occur due to cross traffic at the bulk bin installation location. When feed is delivered, the driver must exit the truck to open the bin lid, transfer feed from the truck, and close the lid. The transfer of disease to the facility occurs when bulk bins are inspected or serviced by facility staff who then re-enter a production facility. Current practices at bulk bin installation locations do not sufficiently limit or eliminate cross-traffic contamination. Additionally, current practices do not provide information about facility traffic.

Pavlicek, U.S. Pat. No. 4,267,936, and Pollock, U.S. Pat. No. 5,218,784, teach the most common method to open a bulk bin lid, a chain that extends from the lid down the side of the bulk bin. To fill the bulk bin the driver exits the vehicle, pulls on the chain and secures it to a latch. When the delivery is complete, the chain is released and the lid closes. This method does not allow for remote control and activation as required by modern bio-security requirements.

Thompson, U.S. Pat. No. 4,625,888, and Christianson, U.S. Pat. No. 4,747,244 teach complex and impractical methods of cranks, pulleys, cables and slides to open and close a bulk bin lid from the ground.

Poncsak, U.S. Pat. No. 9,919,867, teaches a method for opening and closing a bulk storage bin using a linear actuator mounted at the top of the bin and directly connected to the lid. The actuator is activated by a control box which can be controlled remotely by electronic communications. The installation and service of a top mounted system makes this solution, especially difficult and costly for retrofitting to a current system and requires high safety precautions during installation. The taught method is rigidly connected and cannot be disconnect without climbing to the bin top. Therefore, in the case of a power failure or other problem the lid is inoperable.

Therefore, for all the reasons stated herein, there is a need for a better remotely mounted actuator that will open and close a storage bin lid on new or retro fit bulk tank applications, which is easily installed and serviced from a near ground location and can be operated manually in the event of a system failure.

Thus, it is an object of the disclosure to mount the bin lid actuator at or near ground level.

Another object of the disclosure is no requirement to drill any additional holes in structure or bin.

Yet another object of the disclosure is the lid can still be opened manually without disconnecting.

Another object of the disclosure is the actuator can be disconnected from the bin lid without tools.

Yet another object of the disclosure is to function in all environmental conditions, such as snow, ice, water, wind, and extreme temperatures.

Another object of the disclosure is to minimize parts.

Yet another object of the disclosure is to minimize the number of components.

Another object of the disclosure is to simplify assembly.

Yet another object of the disclosure is minimizing actuator stroke required.

Another object of the disclosure is a mechanical override means and method.

Yet another object of the disclosure is the central control box can be controlled remotely.

Another object of the disclosure is the central control box can be controlled manually.

Yet another object of the disclosure is the central control box can be connected to as many actuators as a site requires.

Another object of the disclosure is safe to service.

Another objective of the disclosure is to associate the operation of the device to an overall digital biosecurity system to record the driver's and/or feed truck's presence on the site and that visits impact to biosecurity.

Another objective of the disclosure is to associate the operation of the device to a particular feed delivery order to assure the driver, upon operation of the control box, is at the correct site.

### BRIEF SUMMARY OF THE DISCLOSURE

The disclosure relates to a bulk storage bin and delivery system installation used to store and deliver granular products to manufacturing or production systems such as feed processing or animal production in confinement buildings. The granular material is top loaded into a bulk storage bin when an input bin lid is opened by pulling and latching a lid cable, chain, or other tension force member. When loading is complete, the input bin lid is returned to a closed position with restitution force(s) which may be singular or a combination of torsion, compression or tension spring and gravitational force when the at least one cable is released. A guide channel plate comprises an elongated member, a first guide channel comprising a first slot formed within and along the length of the guide channel plate, and a second guide channel comprising a second slot formed within and along the length of the guide channel plate and parallel to the first guide channel slot. A block plate fits within the first and second guide channels and is secured by a block plate clamp. The block plate connects to a linear actuator that is secured to a support member of the bin. A slide block fits compressively within the first and second guide channels thus securing a flexible link assembly and wherein the slide block connects to the linear actuator. A connector plate allows connecting and disconnecting of the linear actuator.

The knowledge of herd health and a method to restock feed bulk bins without exiting the truck would eliminate the exposure between facilities. Furthermore, the development and deployment of unique delivery sequences to service infected and non-infected herds eliminate cross site vehicular traffic. For example, all non-infected barns are delivered first and then the infected barns, followed by truck cleaning and disinfection procedures; or trucks are restricted to specific barn infections and never enter a healthy site.

### BRIEF DESCRIPTION OF THE DRAWINGS

FIG. 1 depicts an isometric view of the granular bulk supply bin installation with closed lid and linear actuator mounted to supporting leg structure at ground level according to one embodiment.

FIG. 2 depicts an isometric view of the granular bulk supply bin installation with open lid and linear actuator mounted to supporting leg structure at ground level according to one embodiment.

FIG. 3 depicts an isometric view of the mountable actuator assembly mounted to support column according to one embodiment.

FIG. 4 depicts an isometric view of the components of the mountable actuator assembly according to one embodiment.

FIG. 5 depicts a front view of the guide structure used to mount all hardware and then attach to the granular bulk supply bin supporting leg structure according to one embodiment.

FIG. 6 depicts a top sectioned view of the block plate clamp tabs and guide channel clamp tabs intersecting the block plate and guide channel prior to bending according to one embodiment.

FIG. 7 depicts an isometric view of the actuator, block plate, slide block and the flexible link assembly according to one embodiment.

FIG. 8 depicts an isometric view of the slide block according to one embodiment.

FIG. 9 depicts a front section view of the slide block compressed against the guide channel constraining the flexible link assembly according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

Disclosed is a bulk bin lid opener designed to eliminate cross-traffic contamination caused by delivery and other trucks and personnel traveling between production facilities. If a bulk bin can be opened and closed without the driver exiting the truck, the cross-traffic contamination could be eliminated. Additionally, when the remote control device for opening and closing the bulk bin lid also contains GPS tracking, such as a smart phone, it is possible to expand the knowledge of facility traffic and mitigate disease spread.

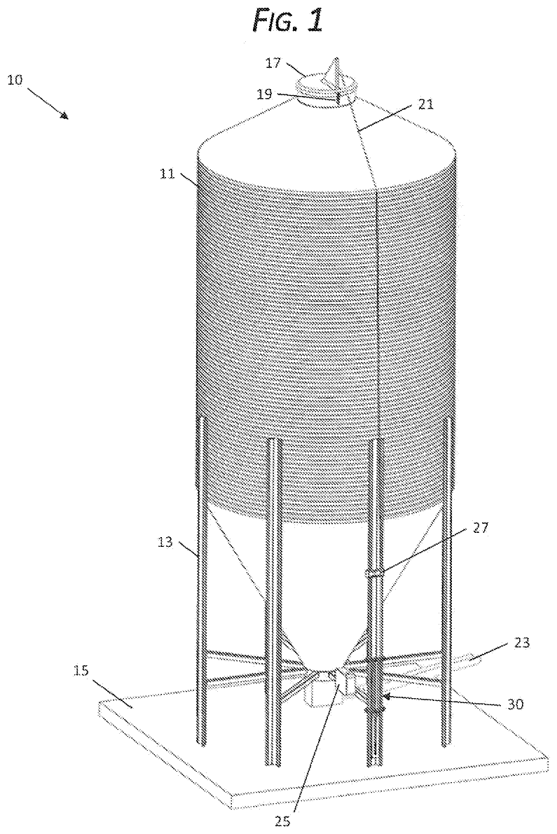

As shown in FIG. 1, the at least one bulk storage bin and delivery system installation 10 is shown with at least one bulk supply bin 11 used to store and deliver granular products to manufacturing or production systems such as feed processing or animal production in confinement buildings. In this instance, the bulk granular product is transferred from the at least one bulk supply bin 11 by a bulk output delivery system 23 such as a continuous chain or auger system to the point of use. The at least one bulk supply bin 11 is secured to and supported by at least one support column 13 which is secured to the at least one foundation 15, a common installation method is for foundation 15 to comprise a poured concrete pad.

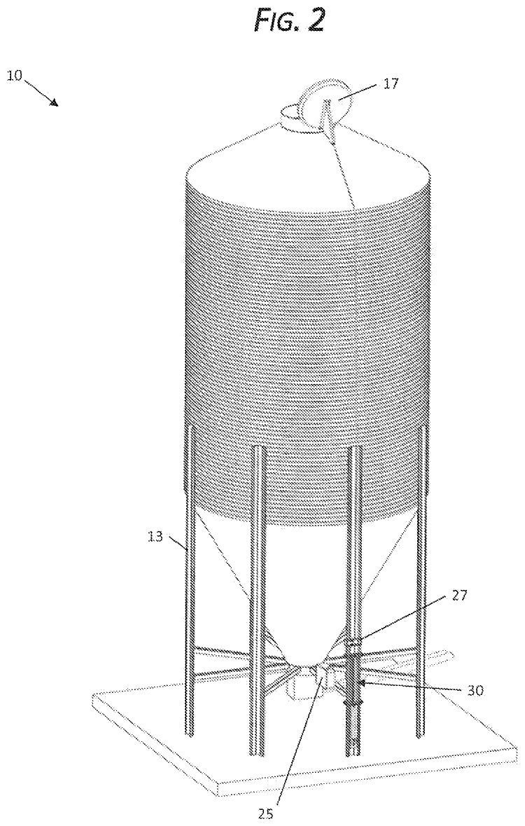

As shown in FIG. 2, the granular material is top loaded when the at least one input bin lid 17 is pivoted open about the at least one hinge 19 when the at least one lid cable 21, chain, or other tension force member is pulled and latched. When loading is completed, the at least one input bin lid 17 must be returned to a closed position with restitution force(s) which may be singular or a combination of torsion, compression or tension spring and gravitational force when the at least one cable 21 is released.

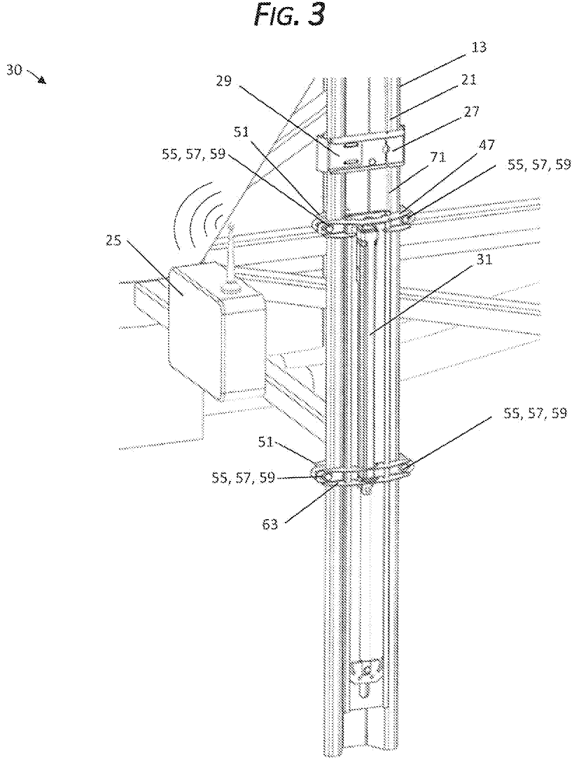

As shown in FIG. 3, the at least one mountable actuator assembly 30 is positioned in proximity to ground level and is secured to the at least one support column 13. Proximity to the ground eliminates risks associated with climbing to install, service, or manually override the actuator system. In the event of a failed opening or closing function, the at least one lid cable 21 or the at least one flexible link assembly 70 is disconnected at the at least one connector plate 27.

The at least one connector plate 27 allows connection to the lid cable 21 and the flexible link assembly 70 without the need for tools.

The at least one linear actuator 31 is powered and controlled by the at least one control box 25. The at least one control box 25 provides manual or remote-controlled actuation for at least one input bin lid 17, and is manually, or remotely controlled. Remotely controlled lid operation includes programs hosted on a computer, phone, or cloud applications. Remote control applications further enhance control and management of the material, bin and bin site access improving bio-security control.

A remote control communicates to the control box 25 using programs hosted on a computer, phone, or cloud applications. In one arrangement, the remote control may comprise a computer, smart phone, tablet, or other device capable of communicating with the control box 25. The remote control may contain a GPS tracking mechanism which can determine to location of the remote control. Farm management software running on a computer, phone, or cloud application may log the date/time the driver and/or feed truck arrives inside and exits the farm's geofence, verify the required biosecurity rules related to a given driver and/or feed truck, automatically verify that the exact bin being opened matches to corresponding order, automatically close the lid when the driver leaves the geofence zone of the site, and/or notify the farm owner or other stakeholders that the ordered feed has been delivered through an automatic confirmation system.

The at least one mountable actuator assembly 30, FIG. 3, is shown secured to the at least one support column 13 using the at least one block plate clamp 47, the at least one guide channel clamp 63 and the at least one clamp strap 51. The compressive force between the at least one block plate clamp 47 and the at least one clamp strap 51 secures the at least one mountable actuator assembly 30 to the at least one support column 13. The compressive force between the at least one guide channel clamp 63 and the at least one clamp strap 51 secures the at least one mountable actuator assembly 30 to the at least one support column 13. The compressive clamping force is created using the at least one standard bolt, washer, and nut hardware 55/57/59. The at least one block plate clamp 47 is interlocking with other system components to be disclosed later. The at least one guide channel clamp 63 is interlocking with other system components to be disclosed later.

The at least one mountable actuator assembly 30 is mountable to the at least one foundation 15 with an alternative clamping solution and radially positioned, not shown.

The at least one mountable actuator assembly 30 is mountable spatially between the at least one support column 13 and a successive support column 13, not shown.

The at least one mountable actuator assembly 30 is mountable on any type of bin supporting structure with alternative clamping solutions, not shown.

The at least one mountable actuator assembly 30 is mountable in any planar orientation applying a force to the at least one lid cable 21. For example, to the interior or exterior of a building and a series of guides, not shown.

The at least one mountable actuator assembly 30 is mountable on any type of mobile system, not shown.

The at least one mountable actuator assembly 30 requires no drilling to mount to existing bulk supply bin 11 supporting structural member such as the at least one support column 13 eliminating un-engineered alterations.

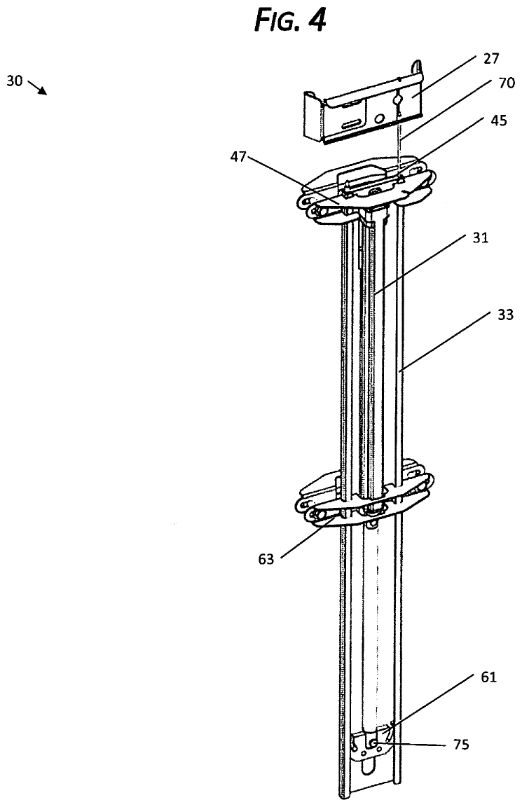

As shown in FIG. 4, the at least one mountable actuator assembly 30 consists of the at least one linear actuator 31, the at least one guide channel plate 33, the at least one block plate 45, the at least one slide block 61, the at least one block plate clamp 47, the at least one guide channel clamp 63, the at least one flexible link assembly 70, and the at least one pin 75 secured with the at least one hairpin cotter pin 77.

The at least one linear actuator 31 is a dual acting electric or air cylinder. The at least one linear actuator 31 is pinned to at least one block plate 45 and at least one slide plate 61 with at least one pin 75 and secured with at least one hairpin cotter pin 77.

The at least one linear actuator 31 can be single acting when closing forces are sufficient enough to close the at least one bin lid 17 and collapse the actuator 31.

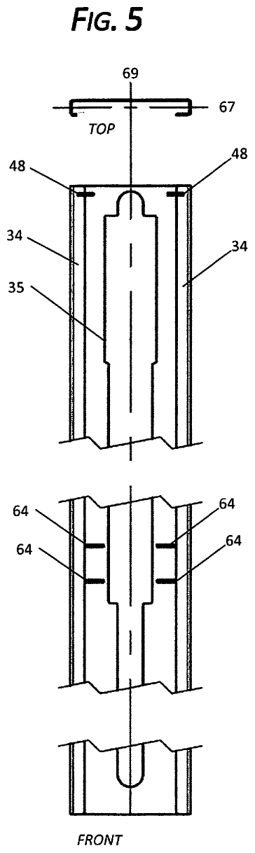

As shown in FIG. 5, the at least one guide channel plate 33 is formed or extruded to create at least one guide channel 34 and an apposing guide channel 34. An actuator relief cut 35 allowing the positioning the at least one linear actuator 31 to axially aligned with the intersection of the horizontal plane 67 and the vertical plane 69 of the apposing guide channel 34. The at least one block plate clamp slot 48 extends through parallel surfaces of the at least one guide channel 34. This structural support on both sides of the at least one guide channel 34 provides required structural support to secure the at least one block plate 45 when the at least one linear actuator 31 is energized. The at least one guide channel clamp slot 64 are for component assembly and securing to the at least one support column 13. Additional features can be added as required for different actuators or mounting configurations.

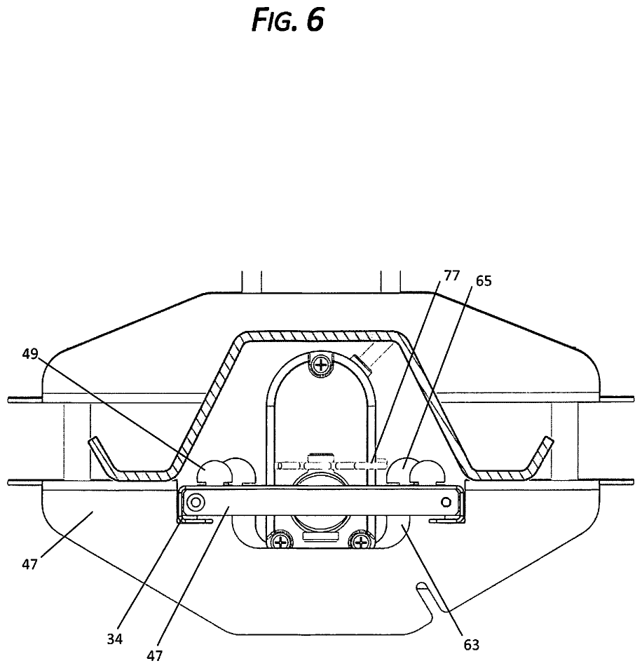

FIG. 6 shows the at least one block plate clamp slot 48 allows the at least one guide channel 34 and the at least one block plate 45 to be intersected by the at least one block plate clamp tab 49 of a block plate clamp 47 and secured forming an assembly. Similarly, the at least one guide channel clamp slot 64 allows the at least one guide channel clamp tab 65 of at least one guide channel clamp 63 to intersect and secure to the at least one guide channel 34 forming an assembly. The at least one block plate clamp tab 49 and the at least one guide channel clamp slot tab 65 are twisted, folded, bent, or deformed after insertion to prevent removal.

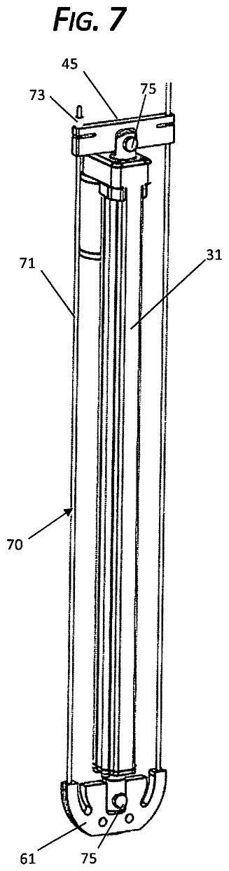

As shown in FIG. 7, the at least one block plate 45 is connected to the at least one linear actuator 31 non-rod end and secured with the at least one pin 75 and hairpin cotter pin 77. The at least one linear actuator 31 extending rod end is connected to the at least one slide block 61 and secured with the at least one pin 75 and hairpin cotter pin 77. The at least one block plate 45 and the at least one slide block 61 are a material that will not damage the at least one flexible link assembly 70, such as ultra-high molecular weight polyethylene (UHMW).

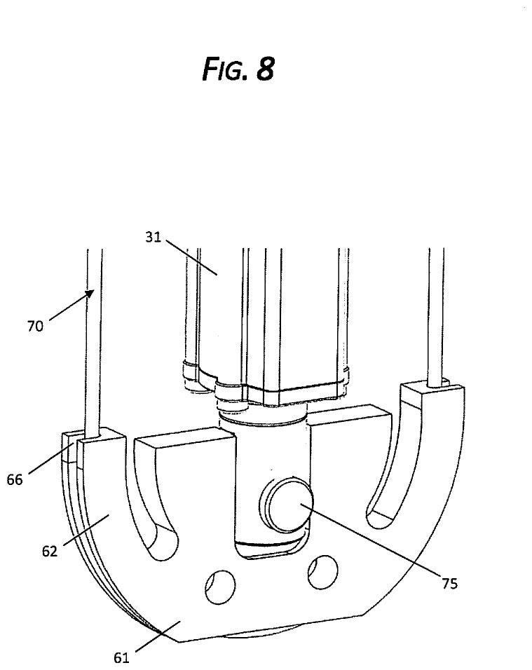

As shown in FIG. 8, the at least one slide block 61 is compressively constrained within the apposing guide channels 34 due to a compressible section 62. The compression force is created by relieving the sides requiring deflection to position in the apposing guide channels 34 and ensuring an interference fit. The compressive contact between the at least one compressible section 62 with the surface of the at least one guide channel 34 ensures the flexible link assembly 70 is properly positioned and constrained. The at least one slide block 61 has at least one flexible link assembly guide channel 66 which symmetric to the horizontal plane 67 and arcs around the end of the at least one slide block 61 approximately 180 degrees.

In one embodiment the at least one flexible link assembly 70 is a length of wire rope 71 with a wire rope stop 73 compressed on each end. The at least one flexible link assembly extends through a hole or profile in the at least one block plate 45 extending to and around the at least one slide block 61 wraps around and constrained in the at least one flexible link assembly guide channel 66, then extending opposite and parallel through a hole or profile in the at least one block plate connecting to the at least one connector plate 27. The at least one flexible link assembly 70 is disclosed as a cable assembly, but could be a tape, rope, or other flexible two force member without departing from the scope of the disclosure.

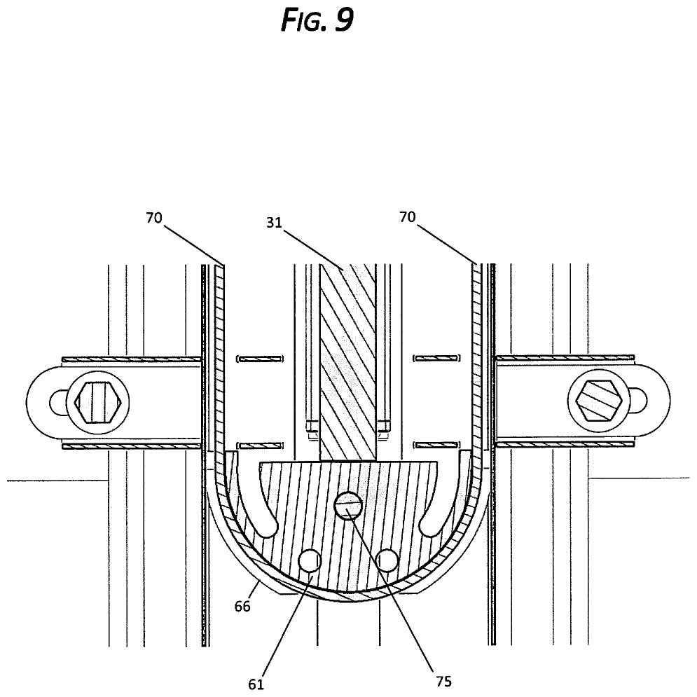

FIG. 9 shows a sectional view of the at least one slide block 61 in compression against the at least one guide channel 34 and the at least one flexible link assembly 70 wrapped around the at least one flexible link assembly guide channel 66.

The disclosed solution by looping the at least one flexible link assembly 70 around the at least one slide block 61 and connecting to the at least one lid cable 21 doubles the at least one linear actuator 31 stroke length. This amplification of stroke does reduce the at least one actuator 31 maximum force in half. The at least one actuator assembly 30 mounted in a near ground location provides a reliable, compact, and safe to service solution. When the control receives a manual or remote signal the linear actuator 31 extends at a predetermined stroke length. The solution provides a durable and cost-effective method to open granular material bin lids and improving the bio-security of existing and new bulk material bin installations.

The at least one flexible link assembly 70, the at least one connector plate 27, and the existing lid cable 21 provide needed flexibility for correct installation and lid opening angle. For instance, if the total stroke of the actuator results in a lid angle to great an adjustment at the at least one connector plate 27 is made, the at least one flexible link assembly 70 extends below, not in contact with the at least one slide block 61. This is acceptable since the at least one flexible link 70 is retained in proper location by the compressive contact between the at least one slide block 61 and the at least one guide channel 34. Upon energization, the at least one linear actuator 31 extends until contact with the at least one flexible link assembly 70 occurs and the at least one input bin lid 17 opens.

The closed bulk storage bin installation 10 has many benefits and advantages including, but not limited to controlling access, remotely opening and closing, and easily disconnecting the actuator if manual operation is required. These and other benefits and advantages are apparent from the specification and claims.

### REFERENCE NUMERALS

10 Closed bulk storage bin installation
11 Bulk supply bin
13 Support column
15 Foundation
17 Input bin lid
19 Hinge
21 Lid cable
23 Bulk output delivery system
25 Control box
27 Connector plate
30 Mountable actuator assembly
31 Linear actuator
33 Guide channel plate
34 Guide channel
35 Actuator relief cut
45 Block plate
47 Block plate clamp
48 Block plate clamp slot
49 Block plate clamp tab
53 Actuator clamp
55 Bolt
57 Washer
59 Nut
61 Slide block
62 Slide block compressible section
63 Guide channel clamp
64 Guide channel clamp slot
65 Guide channel clamp tab
66 Flexible member assembly guide channel
67 Horizontal plane
69 Vertical plane
70 Flexible link assembly
71 Wire rope
73 Wire rope stop
75 Pin
77 Hairpin cotter pin

What is claimed:

1. An electrical and mechanical system for opening a lid located atop a bin comprising, an actuation system configured to open and close the lid, wherein the actuation system is configured to be installed and controlled from a ground location.

2. The system of claim 1 wherein the lid is configured to be opened using a lid cable.

3. The system of claim 2 further comprising:
a guide channel plate comprising an elongated member;
a first guide channel comprising a first slot formed within and along the length of the guide channel plate;
a second guide channel comprising a second slot along the length of the guide channel plate, wherein the second guide channel slot is parallel and apposing to the first guide channel slot;
a block plate fitting within the first and second guide channels wherein the block plate is secured by a block plate clamp, and wherein the block plate connects to a linear actuator that is secured to a support member of the bin;
a first block plate fitting within a first hole positioned within the first guide channel wherein the block plate provides an anchor point for a flexible link connecting the lid to the lid cable;
a second block plate fitting within a second hole positioned within the second guide channel wherein the second block plate provides a guide for the flexible link connecting the lid to the lid cable;
a slide block wherein the slide block fits compressively within the first and second guide channels thus securing the flexible link assembly and wherein the slide block connects to the linear actuator;
a connector plate configured to allow connecting and disconnecting of the linear actuator;
a control box which connects to the linear actuator;
a remote control which communicates to the control box.

4. The system of claim 1 further comprising a remote control configured to open and close the lid, wherein the remote control comprises a GPS tracking mechanism configured to determine a location of the remote control.

5. The system of claim 4 wherein software communicating with the remote control logs one or more dates and times in which a truck arrives inside a geofence of the farm.

6. The system of claim 4 wherein software communicating with the remote control verifies one or more required biosecurity rules related to a given driver or truck.

7. The system of claim 4 wherein software communicating with the remote control automatically verifies that a bin being opened matches to a corresponding order.

8. The system of claim 4 wherein software communicating with the remote control automatically closes the lid when the truck leaves a geofence zone of the farm.

9. The system of claim 4 wherein software communicating with the remote control automatically notifies an owner of the farm or other stakeholders that feed has been delivered.
